(19) United States
(12) Patent Application Publication
(10) Pub. No.: US 2008/0059753 A1
(43) Pub. Date: Mar. 6, 2008

(54) Scheduling operations corresponding to store instructions

(76) Inventors: Sebastien Hily, Hillsboro, OR (US); Zhongying Zhang, Portland, OR (US); Ranjani Iyer, Beaverton, OR (US); Stephan Jourdan, Portland, OR (US); Per Hammarlund, Hillsboro, OR (US)

Correspondence Address: CAVEN & AGHEVLI;c/o INTELLEVATE, P.O. BOX 52050, MINNEAPOLIS, MN, 55402, US

(21) Appl. No.: 11/512,819

(22) Filed: Aug. 30, 2006

(51) Int. Cl. G06F 12/00

(52) U.S. Cl. 711/203

(57) ABSTRACT

Methods and apparatus to redispatch an operation for execution in a processor are described. In one embodiment, a virtual address corresponding to a store instruction may be reselected for translation into a physical address in response to remaining unselected during a previous selection process. Other embodiments are also described.

### BACKGROUND

The present disclosure generally relates to the field of electronics. More particularly, an embodiment of the invention relates to techniques for scheduling one or more operations corresponding to a store instruction in a processor.

In some processors, if an operation corresponding to a store instruction (such as an operation associated with computing the target address of the store instruction) is blocked, the operation may not be redispatched until it is at retirement (or next in line to be retired). This approach may cause delays in completing operations associated with store instructions, which, in turn, may reduce processor performance.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates a block diagram of portions of a processor core and other components of a computing system, according to an embodiment.

FIG. 2 illustrates a block diagram of a store address scheduler, according to an embodiment.

FIG. 3 illustrates a flow diagram of a method to redispatch a uop for execution, according to an embodiment.

FIGS. 4-6 illustrate block diagrams of computing systems in accordance with various embodiments of the invention.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various mechanisms, such as integrated semiconductor circuits (“hardware”), computer-readable instructions organized into one or more programs (“software”), or some combination of hardware and software. For the purposes of this disclosure reference to “logic” shall mean either hardware, software, or some combination thereof. Also, the use of “instruction” or “micro-operation” (which may be referred to as “uop”) herein may be interchangeable.

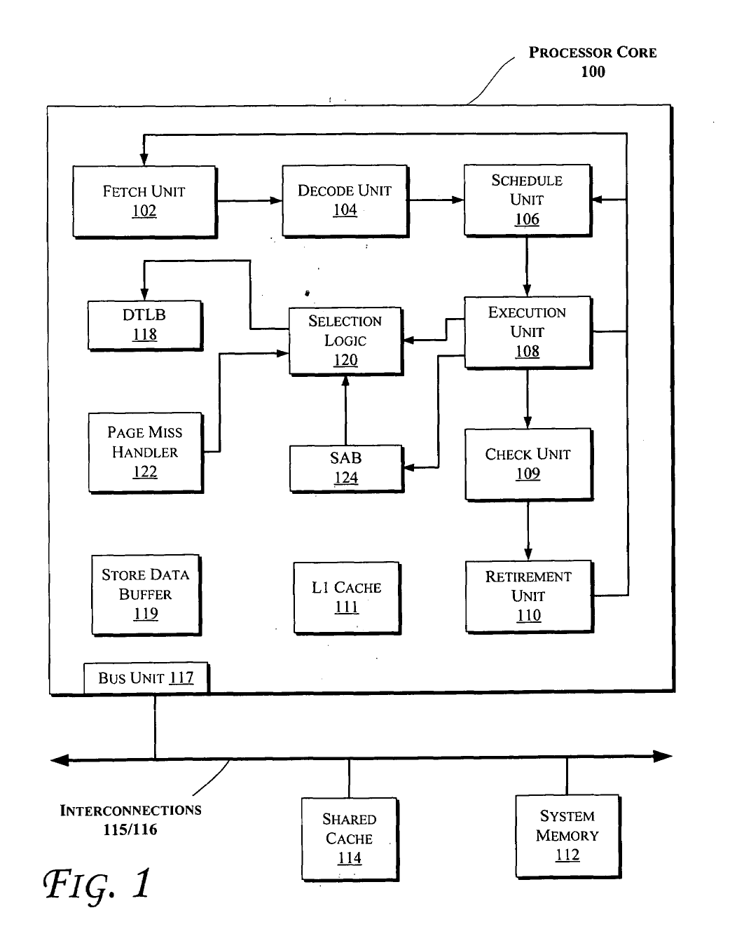

Some of the embodiments discussed herein may be utilized to reselect a virtual address to be translated into a physical address after the virtual address remains unselected during a previous selection process. In an embodiment, a uop may be redispatched for execution in a following clock cycle (e.g., prior to the uop becoming the oldest operation stored in a store address buffer). Moreover, the redispatching of the uop may reduce the latency associated with waiting for the uop to be dispatched from a store address buffer of a processor core, as will be further discussed herein with reference to FIGS. 1-6.

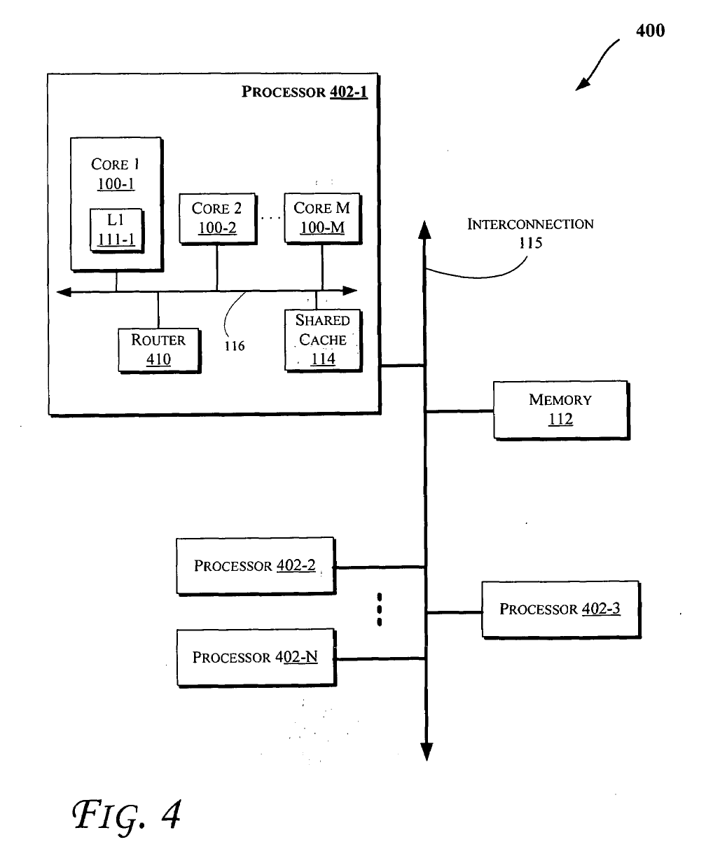

More particularly, FIG. 1 illustrates a block diagram of portions of a processor core 100 and other components of a computing system, according to an embodiment of the invention. In one embodiment, the arrows shown in FIG. 1 indicate the flow direction of signals in the core 100. To reduce obscuring the illustrated embodiment, all connections between the components of the processor core 100 are not shown in FIG. 1. However; various components of the processor core 100 may communicate with each other, as may be suggested by various operations discussed herein. Also, as will be further discussed herein, e.g., with reference to FIGS. 4-6, one or more processor cores (such as the processor core 100) may be implemented on a single integrated circuit chip (or die). Moreover, the chip may include one or more shared or private caches, interconnects, memory controllers, etc.

As illustrated in FIG. 1, the processor core 100 may include a fetch unit 102 to fetch instructions for execution by the core 100. The instructions may be fetched from any storage devices such as the memory devices discussed with reference to FIGS. 4-6. The processor core 100 may include a decode unit 104 to decode the fetched instruction. For instance, the decode unit 104 may decode the fetched instruction into a plurality of uops.

The processor core 100 may further include a schedule unit 106 (which may be a reservation based (RS) scheduler in an embodiment). The schedule unit 106 may store decoded instructions (e.g., received from the decode unit 104) until they are ready for dispatch, e.g., until all source values of a decoded instruction become available. For example, with respect to an “add” instruction, the “add” instruction may be decoded by the decode unit 104 and the schedule unit 106 may store the decoded “add” instruction until the values that are to be added become available. Hence, the schedule unit 106 may schedule and/or issue (referred generically herein as “dispatch”) decoded instructions to various components of the processor core 100 for execution, such as an execution unit 108. The execution unit 108 may execute the dispatched instructions after they are decoded (e.g., by the decode unit 104) and dispatched (e.g., by the schedule unit 106).

In an embodiment, the execution unit 108 may include more than one execution unit, such as a memory execution unit, an integer execution unit, a floating-point execution unit, or other execution units. The execution unit 108 may execute instructions (or uops) out-of-order in some embodiments. Also, in one embodiment, an address may be generated at execution (e.g., by a component of the execution unit such as an address generation unit (AGU)) and used by a memory execution unit to perform memory-related operations. The execution unit 108 may also perform various arithmetic operations such as addition, subtraction, multiplication, and/or division, and may include one or more an arithmetic logic units (ALUs). In an embodiment, a co-processor (not shown) may perform various arithmetic operations in conjunction with the execution unit 108. In turn, the executed instructions may be checked by check unit 109, e.g., to ensure that the instructions were executed correctly. A retirement unit 110 may retire executed instructions after they are committed. Retirement of the executed instructions may result in processor state being committed from the execution of the instructions, physical registers used by the instructions being de-allocated, etc.

As illustrated in FIG. 1, the retirement unit 110 may communicate with the schedule unit 106 to provide data regarding committed instructions. Moreover, the execution unit 108 may communicate with the schedule unit 106 to provide data regarding executed instructions, e.g., to facilitate dispatch of dependent instructions. As a result, the processor core 100 may be an out-of-order processor core in one embodiment. Also, the execution unit 108 may communicate with the fetch unit 102, for example, to instruct the instruction fetch unit 102 to refetch an instruction when a branch misprediction or prediction violation occurs.

In one embodiment, such as shown in FIG. 1, the processor core 100 may include a level 1 (L1) cache 111 to locally store data (e.g., including instructions) that may be stored in a system memory 112 and/or a shared cache 114. As shown in FIG. 1, the core 100 may communicate with the shared cache 114 and/or the system memory 112 through one or more interconnections (or buses) 115 and/or 116. The core 100 may further include a bus unit 117 to facilitate communication between the interconnections 115/116 and the core 100.

Additionally, the processor core 100 may include a data translation lookaside buffer (DTLB) 118, e.g., to enable translation from virtual to physical addresses. For example, when a store instruction is decoded by the decode unit 104 into a store address computation uop (e.g., an STA uop in accordance with at least one instruction set architecture) and a store data uop (e.g., an STD uop in accordance with at least one instruction set architecture), the store address computation uop may utilize the data stored in the DTLB 118 to compute the physical address of data associated with the decoded store instruction. Furthermore, a store data buffer 119 may store one or more bits corresponding to pending memory store operations that have not been written back (or committed) to a memory (e.g., which may be external to the processor core 100 in an embodiment, such as the memory 112).

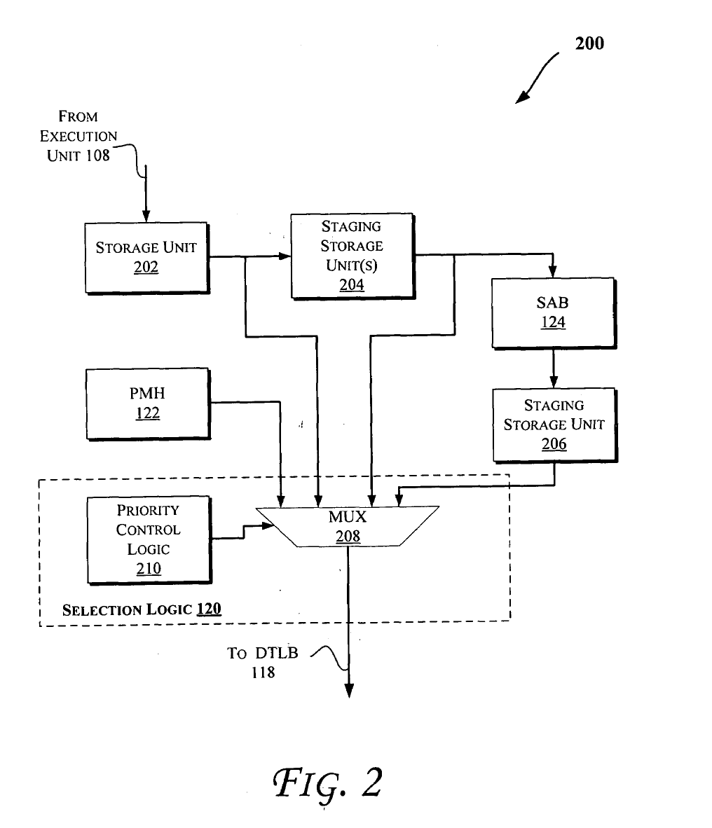

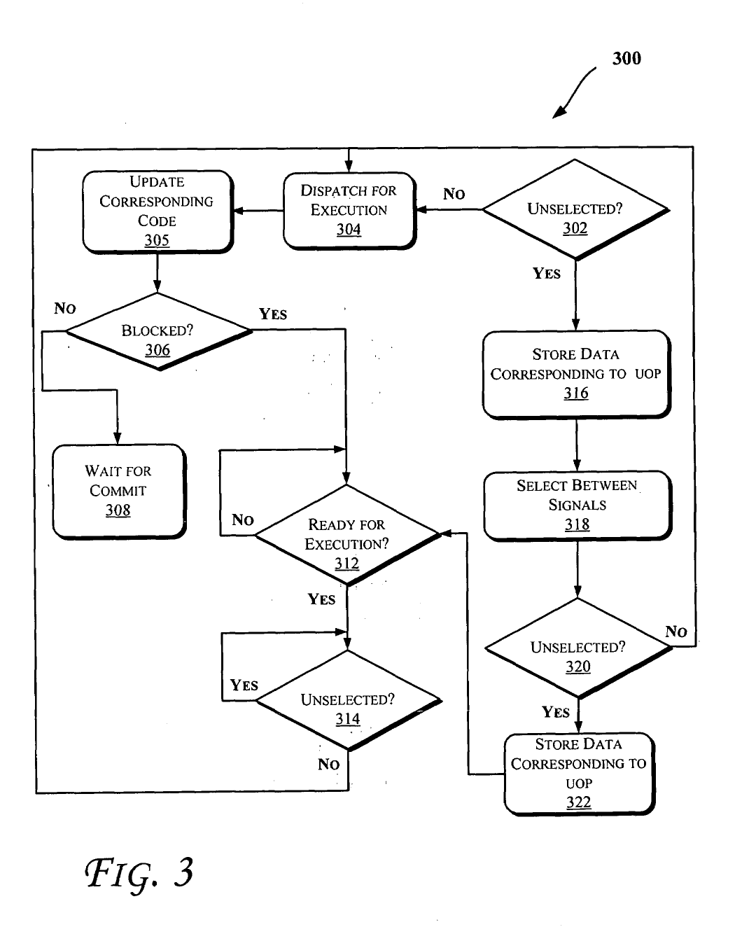

As illustrated in FIG. 1, the core 100 may include a selection logic 120 to select between one or more signals to generate a signal to cause redispatch (or rescheduling) of a uop for execution, as will be further discussed with reference to FIGS. 2-3. The core 100 may further include a page miss handler 122 (e.g., to handle misses in the DTLB 118) and/or a store address buffer (SAB) 124, the entries of which, may store one or more bits of information corresponding to store uops that are waiting to be redispatched or committed, such as one or more bits corresponding to addresses of the uops. The SAB 124 may store a portion of data stored in a store buffer in one embodiment. As such, the SAB 124 may be optional in some embodiments (and the same store buffer may be instead used in some embodiments discussed herein with reference to the SAB 124).

FIG. 2 illustrates a block diagram of a store address scheduler 200, according to an embodiment. In an embodiment, the scheduler 200 illustrates further details of an embodiment of the invention that may be used in a processor core (such as the core 100 of FIG. 1) to reschedule a uop corresponding to a store instruction (such as a store address computation uop).

Referring to FIGS. 1-2, the scheduler 200 may include a storage unit 202 (e.g., such a latch) that receives and stores one or more bits from the execution unit 108 corresponding to a uop dispatched for execution (such as a store address computation uop). A staging storage unit 204 (which may be a latch in an embodiment) may store one or more bits corresponding to the dispatched uop. Data from the staging storage unit 204 may be stored in an entry of the SAB 124. The SAB 124 may provide information corresponding to the most senior (e.g., oldest) entry in the SAB 124 or an entry that is ready for execution (e.g., such as indicated by a corresponding block code stored in the SAB 124) to a staging storage unit 206 (which may be a latch in an embodiment) for dispatch to a multiplexer (MUX) 208. As shown in FIG. 2, the multiplexer 208 may also receive other signals. In some embodiments, the multiplexer 208 may receive a signal corresponding to a virtual address that is to be translated into a physical address (e.g., via the DTLB 118) from one or more of the page miss handler 122, the storage unit 202, the staging storage unit 206, and/or the staging storage unit 204.

Moreover, the multiplexer 208 may select one of its input signals based on a selection signal generated by a priority control logic 210. In an embodiment, the selection logic 120 may include the logic 210 and/or the multiplexer 208. Various priority schemes may be used by the logic 210. For example, the logic 210 may afford priority in the following order (from high to low): (1) PMH 122 dispatch of uop (e.g., after completion of a page walk (or second level TLB (STLB) access (not shown), for example in embodiments where the DTLB 118 has multiple levels); (2) redispatch of a uop from the SAB 124; (3) redispatch from the staging storage unit 204 (which may also be referred to as a skid buffer); and (4) dispatch from the storage unit 202. The output of the multiplexer 208 may be provided to the DTLB 118, e.g., to perform address translation such as discussed with reference to FIG. 1, to a cache 111 or directly back to the SAB 124.

Furthermore, in one embodiment, the storage unit 202, staging storage unit 204, and the staging storage unit 206 may operate in sequential clock cycles. For example, data store in the unit 202 may be output during a first clock cycle, data store in the storage unit 204 may be output during a second clock cycle, and data stored in the storage unit 206 may be output during a third clock cycle, where the third clock cycle may immediately follow the second clock cycle and the second clock cycle may immediately follow the first clock cycle. Therefore, the staging storage unit 204 may allow for redispatch of a uop prior to the same uop reaching retirement (e.g., becoming the senior uop or oldest entry) in the SAB 124. Such an embodiment may reduce the latency associated with waiting for a blocked uop to be rescheduled for execution and/or dispatched from the SAB 124. Also, the uop may be redispatched from the staging storage unit 204 after it fails to be selected from the storage unit 202 (and prior to reaching the SAB 124). The latter embodiment may reduce latency and improve performance.

FIG. 3 illustrates a flow diagram of a method 300 to redispatch a uop for execution, according to an embodiment. In some embodiments, various components discussed with reference to FIGS. 1-2 and 4-6 may be utilized to perform one or more of the operations discussed with reference to FIG. 3.

FIG. 3 is a flow diagram illustrating operations that may be performed in accordance with at least one embodiment of the invention. Referring to FIG. 3, at an operation 302, it may be determined whether a uop that corresponds to a store instruction and/or store address computation remains unselected for execution. In an embodiment, the logic 210 of FIG. 2 may determine whether a uop is selected from the storage unit 202 at operation 302. If the uop is selected at operation 302, the selected uop may be dispatched for execution at an operation 304. In an embodiment, the multiplexer 208 may select the uop from the unit 202 for dispatch at operation 304. At an operation 305, a code may be updated to indicate that a corresponding operation is to be blocked or unblocked. In an embodiment, operation 305 may be performed by writing a code into a corresponding entry of the SAB 124. At an operation 306, if the uop remains unblocked (e.g., as indicated by the code updated at operation 305), the uop may be executed to completion and the corresponding results committed (such as discussed with reference to FIG. 1) at operation 308.

In one embodiment, the, uop may be blocked at operation 306 due to various conditions such as a resource conflict or in response to a signal generated by the DTLB 118 (e.g., due to a miss in the DTLB 118, and, for example, where the PMH 122 may be busy, for example) and/or an overflow (e.g., a full queue) in the fetch unit 102. If the uop is blocked at operation 306, once the blocking condition is resolved (e.g., after the uop is marked as ready for dispatch, for example by clearing the block code stored at operation 305), it may be determined whether a selection has been made between various inputs at an operation 314. In an embodiment, the selection logic 120 may select between the entries of the SAB 124 and other inputs to the multiplexer 208 at operation 314. If the ready entry wins selection at operation 314, the method 300 may resume at operation 304 (e.g., by scheduling the uop in age order for execution). Hence, in some embodiments, at operation 314, a blocked uop (e.g., blocked at operation 306) may be redispatched for execution, e.g., prior to the blocked uop reaching retirement (e.g., by becoming the senior uop or oldest entry) in the SAB 124 in accordance with one embodiment.

At operation 302, if the uop loses selection, data corresponding to the uop may be stored at an operation 316. In an embodiment, data corresponding to the uop may be stored in the staging storage unit 204 at operation 316. At an operation 318, a selection may be made between various inputs. In an embodiment, at operation 318, the selection logic 120 may cause a selection between inputs to the multiplexer 208 (including the signal generated by the staging storage unit 204). At an operation 320, if the uop remains unselected, data corresponding to the uop may be stored at an operation 322. Otherwise, if the uop is selected at operation 320, the method 300 may resume at operation 304. In an embodiment, at operation 320, if the priority control logic 210 causes the multiplexer 208 to select the output of the staging storage unit 204 as its output, the method 300 may resume at operation 304. In one embodiment, at an operation 322, data corresponding to the uop may be store in an entry of the SAB 124 such as discussed with reference to FIG. 2. After operation 322, the method 300 may resume at operation 312 (e.g., by waiting for the corresponding entry in the SAB 124 to become ready for execution in accordance with one embodiment).

FIG. 4 illustrates a block diagram of a computing system 400, according to an embodiment of the invention. The system 400 may include one or more processors 402-1 through 402-N (generally referred to herein as “processors 402” or “processor 402”). The processors 402 may communicate via the interconnection network or bus 115. Each processor may include various components some of which are only discussed with reference to processor 402-1 for clarity. Accordingly, each of the remaining processors 402-2 through 402-N may include the same or similar components discussed with reference to the processor 402-1.

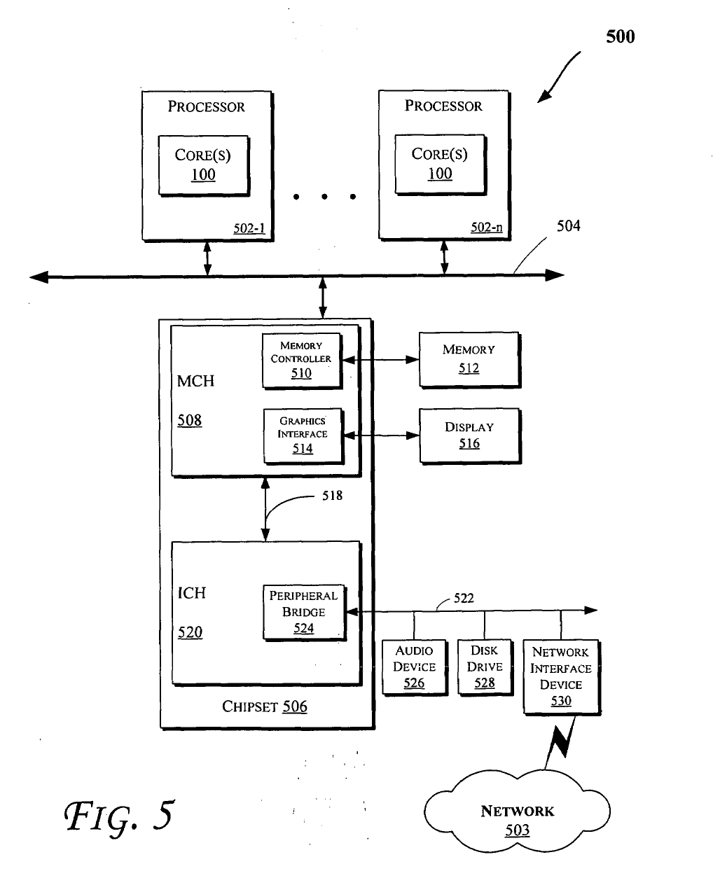

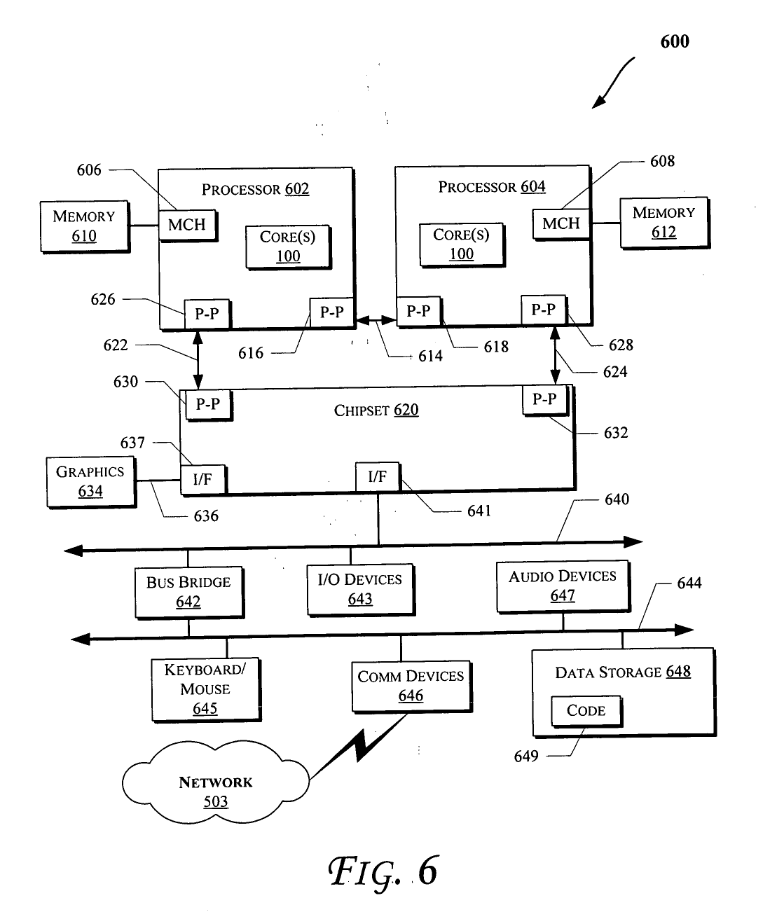

In an embodiment, the processor 402-1 may include one or more processor cores 100-1 through 100-M (which may be the same or similar to the processor core 100 of FIG. 1, and referred to herein as “cores 100” or “core 100”), the shared cache 114, and/or a router 410. The processor cores 100 may be implemented on a single integrated circuit (IC) chip. Moreover, the chip may include one or more shared caches (such as cache 114) and/or private caches (such as level 1 (L1) cache 111-1, generally referred to herein as “L1 cache 111”), buses or interconnections (such as bus or interconnection network 115 or 116), memory controllers (such as those discussed with reference to FIGS. 5 and 6), or other components.

In one embodiment, the router 410 may be used to communicate between various components of the processor 402-1 and/or system 400. Moreover, the processor 402-1 may include more than one router 410. Furthermore, the multitude of routers (410) may be in communication to enable data routing between various components inside or outside of the processor 402-1.

The shared cache 114 may store data (e.g., including instructions) that are utilized by one or more components of the processor 402-1, such as the cores 100. Further, the shared cache 114 may locally cache data stored in the memory 112 for faster access by components of the processor 402. In an embodiment, the cache 114 may include a mid-level cache (such as a level 2 (L2), a level 3 (L3), a level 4 (L4), or other levels of cache), a last level cache (LLC), and/or combinations thereof. Moreover, various components of the processor 402-1 may communicate with the shared cache 114 directly, through a bus (e.g., the bus 116), and/or a memory controller or hub.

FIG. 5 illustrates a block diagram of a computing system 500 in accordance with an embodiment of the invention. The computing system 500 may include one or more central processing unit(s) (CPUs) 502 or processors that communicate via an interconnection network (or bus) 504. The processors 502 may include a general purpose processor, a network processor (that processes data communicated over a computer network 503), or other types of a processor (including a reduced instruction set computer (RISC) processor or a complex instruction set computer (CISC)). Moreover, the processors 502 may have a single or multiple core design. The processors 502 with a multiple core design may integrate different types of processor cores on the same integrated circuit (IC) die. Also, the processors 502 with a multiple core design may be implemented as symmetrical or asymmetrical multiprocessors. In an embodiment, one or more of the processors 502 may be the same or similar to the processors 402 of FIG. 4. For example, one or more of the processors 502 may include one or more of the cores 100 discussed with reference to FIG. 1. Also, the operations discussed with reference to FIGS. 1-4 may be performed by one or more components of the system 500.

A chipset 506 may also communicate with the interconnection network 504. The chipset 506 may include a memory control hub (MCH) 508. The MCH 508 may include a memory controller 510 that communicates with a memory 512 (which may be the same or similar to the memory 112 of FIGS. 1 and 4). The memory 512 may store data, including sequences of instructions, that may be executed by the CPU 502, or any other device included in the computing system 500. In one embodiment of the invention, the memory 512 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 504, such as multiple CPUs and/or multiple system memories.

The MCH 508 may also include a graphics interface 514 that communicates with a display device 516. In one embodiment of the invention, the graphics interface 514 may communicate with the display device 516 via an accelerated graphics port (AGP). In an embodiment of the invention, the display 516 (such as a flat panel display) may communicate with the graphics interface 514 through, for example, a signal converter that translates a digital representation of an image stored in a storage device such as video memory or system memory into display signals that are interpreted and displayed by the display 516. The display signals produced by the display device may pass through various control devices before being interpreted by and subsequently displayed on the display 516.

A hub interface 518 may allow the MCH 508 and an input/output control hub (ICH) 520 to communicate. The ICH 520 may provide an interface to I/O device(s) that communicate with the computing system 500. The ICH 520 may communicate with a bus 522 through a peripheral bridge (or controller) 524, such as a peripheral component interconnect (PCI) bridge, a universal serial bus (USB) controller, or other types of peripheral bridges or controllers. The bridge 524 may provide a data path between the CPU 502 and peripheral devices. Other types of topologies may be utilized. Also, multiple buses may communicate with the ICH 520, e.g., through multiple bridges or controllers. Moreover, other peripherals in communication with the ICH 520 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 522 may communicate with an audio device 526, one or more disk drive(s) 528, and a network interface device 530 (which is in communication with the computer network 503). Other devices may communicate via the bus 522. Also, various components (such as the network interface device 530) may communicate with the MCH 508 in some embodiments of the invention. In addition, the processor 502 and the MCH 508 may be combined to form a single chip. Furthermore, a graphics accelerator may be included within the MCH 508 in other embodiments of the invention.

Furthermore, the computing system 500 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 528), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

FIG. 6 illustrates a computing system 600 that is arranged in a point-to-point (PtP) configuration, according, to an embodiment of the invention. In particular, FIG. 6 shows a system where processors, memory, and input/output devices are interconnected by a number of point-to-point interfaces. The operations discussed with reference to FIGS. 1-5 may be performed by one or more components of the system 600.

As illustrated in FIG. 6, the system 600 may include several processors, of which only two, processors 602 and 604 are shown for clarity. The processors 602 and 604 may each include a local memory controller hub (MCH) 606 and 608 to enable communication with memories 610 and 612. The memories 610 and/or 612 may store various data such as those discussed with reference to the memory 512 of FIG. 5.

In an embodiment, the processors 602 and 604 may be one of the processors 502 discussed with reference to FIG. 5. The processors 602 and 604 may exchange data via a point-to-point (PtP) interface 614 using PtP interface circuits 616 and 618, respectively. Also, the processors 602 and 604 may each exchange data with a chipset 620 via individual PtP interfaces 622 and 624 using point-to-point interface circuits 626, 628, 630, and 632. The chipset 620 may further exchange data with a graphics circuit 634 via a graphics interface 636, e.g., using a PtP interface circuit 637.

At least one embodiment of the invention may be provided within the processors 602 and 604. For example, one or more of the cores 100 of FIGS. 1 and/or 4 may be located within the processors 602 and 604. Other embodiments of the invention, however, may exist in other circuits, logic units, or devices within the system 600 of FIG. 6. Furthermore, other embodiments of the invention may be distributed throughout several circuits, logic units, or devices illustrated in FIG. 6.

The chipset 620 may communicate with a bus 640 using a PtP interface circuit 641. The bus 640 may communicate with one or more devices, such as a bus bridge 642 and I/O devices 643. Via a bus 644, the bus bridge 642 may communicate with other devices such as a keyboard/mouse 645, communication devices 646 (such as modems, network interface devices, or other communication devices that may communicate with the computer network 503), audio I/O device 647, and/or a data storage device 648. The data storage device 648 may store code 649 that may be executed by the processors 602 and/or 604.

In various embodiments of the invention, the operations discussed herein, e.g., with reference to FIGS. 1-6, may be implemented as hardware (e.g., logic circuitry), software, firmware, or combinations thereof, which may be provided as a computer program product, e.g., including a machine-readable or computer-readable medium having stored thereon instructions (or software procedures) used to program a computer to perform a process discussed herein. The machine-readable medium may include a storage device such as those discussed with respect to FIGS. 1-6.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a bus, a modem, or a network connection). Accordingly, herein, a carrier wave shall be regarded as comprising a machine-readable medium.

Reference in the specification to “one embodiment,” “an embodiment,” or “some embodiments” means that a particular feature, structure, or characteristic described in connection with the embodiment(s) may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features, and/or methodological acts, it is to be understood that claimed subject matter may not be limited to the specific features or acts described. Rather, the specific features and acts are disclosed as sample forms of implementing the claimed subject matter.

What is claimed is:

1. A processor comprising:
a first storage unit to store a virtual address corresponding to a store operation; and
a selection logic to select the virtual address from the first storage unit to be translated into a physical address in response to the selection logic failing to select the virtual address from a second storage.

2. The processor of claim 1, wherein the virtual address is stored in the first storage unit after the virtual address is stored in the second storage unit.

3. The processor of claim 1, wherein the operation corresponds to a store instruction.

4. The processor of claim 1, further comprising a store address buffer to store one or more bits corresponding to the virtual address in an entry of the buffer.

5. The processor of claim 4, wherein the selection logic causes the operation to be redispatched for execution in response to the entry becoming ready.

6. The processor of claim 5, wherein each entry of the store address buffer comprises one or more bits of a block code and wherein the entry corresponding to the virtual address becomes ready in response to a corresponding block code of the entry indicating that the operation is ready for execution.

7. The processor of claim 1, further comprising a priority control logic to generate a signal to cause the selection logic to select the virtual address.

8. The processor of claim 7, wherein the priority control logic generates the signal in response to one or more signals generated by one or more components of the processor, wherein the one or more components comprise:
a page miss handler to handle a miss in a data translation look-aside buffer corresponding to the virtual address;
the first storage unit;
the second storage unit; or
a store address buffer to store one or more bits corresponding to the virtual address.

9. The processor of claim 1, wherein the operation corresponds to a store address computation operation of a store instruction.

10. The processor of claim 1, wherein the processor comprises a plurality of processor cores, wherein at least one of the plurality of processor cores comprises one or more of the selection logic, the first storage unit, or the second storage unit.

11. The processor of claim 1, wherein one or more of the selection logic, the first storage unit, the second storage unit, a plurality of processor cores, or a cache are on a same integrated circuit die.

12. A method comprising:
determining if a virtual address corresponding to a store instruction remains unselected for translation into a physical address; and
selecting the virtual address for translation into the physical address before an operation corresponding to the store instruction reaches retirement.

13. The method of claim 12, wherein the operation reaches retirement once an entry of a store address buffer corresponding to the virtual address becomes an oldest operation in the store address buffer.

14. The method of claim 12, further comprising selecting between one or more signals to generate a signal to cause the selection of the virtual address for translation into the physical address.

15. The method of claim 12, further comprising storing one or more bits corresponding to the operation in an entry of the store address buffer.

16. The method of claim 15, wherein the selection of the virtual address occurs after the entry becomes ready.

17. The method of claim 12, wherein the determining occurs during a first clock cycle and the selecting occurs during a second clock cycle that immediately follows the first clock cycle.

18. A system comprising:
a memory to store a store instruction; and
a processor core to execute an operation corresponding to the store instruction, the processor core to comprise a selection logic to cause the operation to be redispatched for execution before the operation reaches retirement in a store address buffer.

19. The system of claim 18, further comprising a latch to store one or more bits corresponding to the operation.

20. The system of claim 19, wherein the selection logic causes dispatch of the operation for execution based on the one or more bits stored in the latch.

21. The system of claim 18, wherein the memory comprises one or more of a DRAM, SDRAM, or SRAM.

22. The system of claim 18, wherein the selection logic selects a virtual address corresponding to the operation to be translated into a physical address in a next clock cycle which immediately follows a previous clock cycle during which the selection logic fails to select the virtual address to be translated into the physical address.

23. The system of claim 18, further comprising an audio device coupled to the processor core.

24. An apparatus comprising:
a selection logic to reselect a virtual address to be translated into a physical address in response to the selection logic failing to select the virtual address.

25. The apparatus of claim 24, further comprising a plurality of storage units to store the virtual address.

26. The apparatus of claim 24, further comprising a priority control logic to generate a signal to cause the selection logic to select the virtual address.

27. The apparatus of claim 24, wherein the virtual address corresponds to a store instruction.

28. The apparatus of claim 24, wherein the operation corresponds to a store address computation operation of a store instruction.

29. The apparatus of claim 24, wherein the selection logic reselects the virtual address during a first clock cycle that immediately follows a second clock cycle during which the selection logic fails to select the virtual address.

30. The apparatus of claim 24, further comprising a store address buffer to store one or more bits corresponding to the virtual address.
